(19) United States
(12) Patent Application Publication
(10) Pub. No.: US 2009/0074916 A1
(43) Pub. Date: Mar. 19, 2009

(54) Frozen or Chilled Vegetable Objects

(76) Inventors: Willem Pieter Antheunisse, Vlaardingen (NL); Elisabeth Cornelia M. Bouwens, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/793,953

(22) PCT Filed: Dec. 15, 2005
(86) PCT No.: PCT/EP05/13542

§ 371 Date: May 9, 2008

(30) Foreign Application Priority Data
Dec. 23, 2004 (EP) 04078511.5

(51) Int. Cl. A23L 1/212

(52) U.S. Cl. 426/52; 426/615

(57) ABSTRACT

Frozen vegetable objects capable of retaining their shape upon heating to room temperature may be prepared using a covalently cross-linked ferulyolated compound such as pectin.

### FIELD OF THE INVENTION

The invention relates to frozen or chilled vegetables. More in particular, it relates to a frozen or chilled vegetable object capable of retaining its shape upon heating to room temperature.

### BACKGROUND TO THE INVENTION

It is well known that vegetables are healthy food ingredients because of their nutritional value. Health authorities generally recommend a daily intake of about 200 grams per day per person. Many types of vegetables such as spinach are conveniently sold in frozen form. This ensures that the nutritional value is maintained upon storage. Frozen spinach is usually sold in the form of a frozen solid block, but packs containing several smaller frozen blocks of about 10-20 gram each are also in the market. Vegetable objects having attractive shapes can also be prepared in that way. This has the advantage that they vegetables may become more attractive and acceptable to children. In this way kids might like vegetables much more and their moms and dads would be pleased! Unfortunately, the attractive shape of such frozen vegetables usually disappears upon heating, for instance, when they are served on a warm plate.

It is therefore an object of the invention to provide a frozen or chilled vegetable object, which does not lose its shape upon heating to room temperature. Surprisingly, it was found that this object could be achieved by the frozen or chilled vegetable object of the invention which comprises a covalently cross-linked ferulyolated compound.

WO-A-02/071870 (Unilever) discloses a foam wherein the cross-linked pectin is incorporated, as in foodstuff such as mousse, ice cream.

WO-A-00/40098 (Danisco) discloses a fat replacer comprising a pectin composition wherein the pectin composition comprises at least a population of pectin which is covalently cross-linked. A process is disclosed wherein this cross-linked pectin is incorporated in the foodstuff such as yoghurt, mayonnaise or ice cream. Such products are emulsions of oil in water.

### SUMMARY OF THE INVENTION

According to a first aspect, the invention provides a frozen or chilled vegetable object capable of retaining its shape upon heating to room temperature and comprising a covalently cross-linked ferulyolated compound.

According to a second aspect, there is provided a process for preparing such a chilled vegetable object comprising a covalently cross-linked ferulyolated compound.

### DETAILED DESCRIPTION OF THE INVENTION

The invention regards the preparation of a frozen or chilled vegetable object. The vegetable to be used may be any type of vegetable, such as spinach, peas, carrots, broccoli, beans, tomato, rhubarb, endive, purslane, sprouts, asparagus, pulse, celery, cabbage, zucchini, cauliflower. Spinach is preferred. In the context of the present invention the word “vegetable” may also mean fruit, such as mango, peach, kiwi, etc.

The vegetable object of the invention is frozen or chilled. If it is frozen, which is preferred, it has been cooled below its freezing point, which will generally depend on the type of vegetable and the water content and the salt content. Frozen spinach has a temperature of minus 5° C. or lower. However, the vegetable object may also be just chilled, i.e. its temperature is above its freezing point but below room temperature, generally in the order of 0 to 5° C. or maximally 10° C. The objects of the invention have a high vegetable content of at least 30%, preferably at least 50%, more preferably of 70% or even higher.

The vegetable object is prepared using cross-link technology, preferably enzymatic cross-link technology. This means that compounds having ferulyolated groups are added to the vegetable and subsequently cross-linked. Ferulyolated pectin or ferulyolated biopolymers or vanillin attached biopolymers such as chitosan-vanillin are suitable for this purpose.

The selected vegetables loose their three-dimensional structure during processing e.g. by shearing, heating or blending of the vegetables. These vegetables may be put in a new attractive form or shape when they are frozen, but they will loose their attractive shape during thawing or heating of the shape upon hot serving.

By means of pectin cross-linking it proved to be possible to make vegetable objects that keep their attractive shape upon hot serving. It was found that conventional thickening agents could not sufficiently stabilise the vegetable objects of e.g. frozen spinach when they were heated, as for instance in a microwave oven.

Certain polymers containing ferulic acid groups attached to their backbone are known to be gellable by oxidation. An example of these polymers is pectin. The gelling may be achieved by addition of an appropriate amount of an enzyme of the oxidase type, e.g. laccase or peroxidase. The vegetables of the application may contain these enzymes which allows the process to occur without addition of exogenous enzymes.

This coupling is an oxidation reaction, which leads to gel formation or at least increased viscosity of the aqueous phase. The gel forming capacity of e.g. pectins is for examples described in WO-A-98/22513 and WO-A-00/40098 and WO-A-96/03440.

Ferulic acid groups (4-hydroxy-3-methoxy-cinnamyl-groups) are known to be capable of cross-linking in the presence of certain oxidants (e.g. Oosterveld et al; oxidative cross-linking of pectic polysaccharides from sugar beet pulp, Carbohydrate research 328; 199-207, 2000). In the oxidation process a new covalent bond is formed between two individual ferulic acid groups.

The term oxidant is used to indicate an oxidising agent, which can be either a chemical oxidising agent or an enzyme. An enzyme can be used alone or in combination with a co-oxidant such as hydrogen peroxide.

The compound comprising ferulyolated groups is preferably a polymer, more preferred a polysaccharide. Examples of suitable polymers include pectin, arabinan, galactan, cellulose derivatives, galactomannans such as guar gum, locust bean gum, starches or other polymers comprising hydroxyl groups which can be esterified to a ferulic acid group. The polymers comprising ferulic acid groups can be naturally occurring or synthesised polymers. Examples of naturally occurring polymers with ferulic acid groups are sugar beet pectin and arabinoxylanes isolated from cereals.

Synthetic processes to prepare polymers with ferulic acid groups generally include esterification of ferulic acid to a free hydroxyl group situated on the polymer backbone or on a sugar substituent.

In a highly preferred embodiment, the ferulyolated compound is a pectin, even more preferred sugar beet pectin. The principal building units of pectin are smooth homogalacturonic regions and rhamnified hairy regions in which most neutral sugars are located. Arabinose is the predominant neutral sugar. Galactose is present in rhamnogalacturonan. 50-55% of the ferulic acid groups are linked to arabinose units and about 45-50% of the ferulic acid groups are linked to galactose residues.

Preferably 15 to 80% of all ferulic acid groups are oxidised in the final product, after oxidation. It is preferred that the majority of ferulic acid groups is not oxidised before the oxidation. Even more preferred, before oxidation at most 10% of all ferulic acid groups are oxidised.

The oxidation could theoretically be accomplished by the action of powerful chemical oxidants such as potassium periodate, potassium permanganate or potassium ferricyanide. However, because the vegetable object is a food product, the oxidation is preferably accomplished by use of an oxidising enzyme such as a peroxidase, a polyphenol oxidase e.g. catechol oxidase, tyrosinase, or a laccase.

Peroxidases can be divided into those originating from plants, such as tomato peroxidase or soy bean peroxidase, fungi or bacteria and those originating from a mammalian source. Laccases are obtainable from a variety of microbial sources notably bacteria and fungi (including filamentous fungi and yeasts), and suitable examples of laccases include those obtainable from strains of Aspergillus, Neurospora (e.g. N. crassa), Prodospora, Botrytis, Collybia, Fomes, Lentinus, Pleurotus, Trametes [some species/strains of which are known by various names and/or have previously been classified within other genera], Polyporus, Rhizoctonia, Coprinus, Psatyrella, Myceliophtora, Schytalidium, Phlebia or Coriolus.

Preferred enzymes are selected from the group comprising plant peroxidases such as tomato peroxidase, spinach peroxidase, horseradish peroxidase, soy bean peroxidase and laccases that show a redox potential of preferably more than 450 mV as described in E. Solomon et al, Chem. Rev. 1996, p 2563-2605.

In case an enzymatic oxidising system is applied, the enzyme is preferably added in the form of a solution or a dispersion in an aqueous buffer system. The enzymes cited above are suitable enzymes. Some enzymes, such as peroxidases require the presence of a co-oxidant such as hydrogen peroxide for their activity. The co-oxidant is preferably added separately from the enzyme that requires its presence.

The amount of enzyme added is expressed in terms of activity units. Preferably enzyme is present in excess. The amount of enzyme added is preferably such that fast cross-linking occurs. For a peroxidase the amount of enzyme added is preferably from 10 to 100,000 units ABTS activity per ml of liquid.

The oxidation is preferably carried out at a temperature of from −20° C. to 80° C., preferably 4 to 70° C. It will be appreciated that the optimal temperature depends on the oxidation system that has been chosen. Subsequently, the vegetables are frozen or chilled to the desired temperature.

According to another embodiment, the oxidising agent is added to the aqueous phase which already comprises ferulyolated compound, while the enzyme is endogenously present.

The amount of ferulyolated compound is preferably from 0.5 to 2 wt % (g ferulic acid per 100 g pectin). The amount of ferulyolated compound as a stock solution which is used for a barrier is preferably from 6 to 10 wt % (g ferulyolated compound per 100 ml solvent). The solution can be sprayed or applied as such at the surface of the ingredient/product. The ferulyolated compound can also be applied as dry powder which is a mixture of ferulyolated compound and oxidising agent(s). Hydrogen peroxide can be added to solution or can be generated in situ by means of glucose/glucose oxidase addition.

The frozen or chilled vegetable object may optionally further comprise ingredients such as protein, salt, flavour components, colourants, emulsifiers, acidifying agents, (co)-oxidants such as hydrogen peroxide, and the like.

The invention is illustrated in the following examples.

### EXAMPLES

### 1. Frozen Spinach-Shapes

The following mixture was made: 14 g 6% sugar beet pectin (Genu Beta pectin from CP Kelco) pH 5 was added to 26 g spinach (thawed Iglo spinach blocks), 0.5 g sugar and 0.5 g skimmed milk powder. Then 0.1 ml 10% w/v Biobake Wheat (from Quest) and 80 μl 1M hydrogen peroxide was added and the mixture was put in the attractive shapes (star or heart forms). After 10 minutes, the products were carefully taken out of the shapes and were stored frozen. For consumption the frozen objects were heated in a microwave oven for 3 minutes at 600 W for each shape.

### 2. Frozen Multi-Layered Vegetable Shapes

The following mixtures were made:

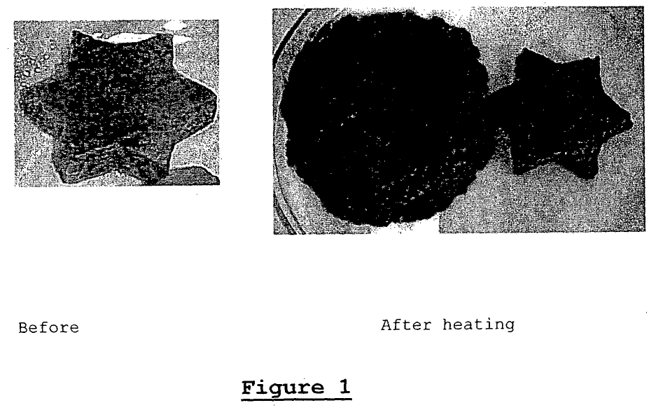

Bottom layer: 14 g 6% pectin pH 5 was added to 26 g smashed carrots, 0.5 g sugar. Then 0.1 ml 10% Biobake wheat and 80 μl 1M hydrogen peroxide was added and the mixture was put in the attractive shapes (filled for ⅓ of the shape of a star or hart). After 5 minutes the following layer was added:
Middle layer: 14 g 6% pectin pH 5 was added to 14 g smashed peas with 12 ml water, 0.5 g sugar. Then 0.1 ml 10% Biobake wheat and 80 μl 1M hydrogen peroxide was added and the mixture was put on top of the other layer. After 5 minutes, the following layer was added:
Top layer: 14 g 6% pectin pH 5 was added to 26 g smashed carrots, 0.5 g sugar. Then 0.1 ml 10% Biobake wheat and 80 μl 1M hydrogen peroxide was added and the mixture was put in the attractive shapes (shape of a star or hart). After 10 minutes the products were carefully taken out of the shapes and were stored frozen. For consumption the frozen shapes were heated in a microwave oven for 3 minutes at 600 W for each shape. Two vegetable objects with attractive shapes were made as described above under (1) and are shown as hot dish in FIG. 1.

### 1. Spinach Shapes.

### 2. Multi Layer Peas/Carrot Shapes

The products were heat- and freeze-stable and contain 75% vegetables. Heating of the products was done in microwave oven for 1 minute at 1,000 W per 50 g product. The end temperature was about 80° C. When the products were heated the shape remained stable/unaffected, while a reference sample containing only spinach in a similar shape was unstable, resulting in one unattractive mash of spinach.

### Example 3

### Benchmark of Spinach Shapes with the Purpose to Stabilized them Upon Heating Using Different Thickening Agents

The following mixture was made: 37.5 g spinach (thawed Iglo spinach blocks) and 12.5 g water with thickening agent. Ingredients were mixed. Samples 2 till 6 were heated for gelling the starch or solving the alginate or HMPC/MC. Shapes were filled with the spinach and thickening agent. In case of alginate Ca was added just before filling the shape with spinach. In sample 7, the enzyme (0.025 g Biobake from Quest) and a very small dosage of hydrogen peroxide (2 mM) were added just before filling the shape. After 10 minutes, the products were frozen. Before heating the spinach was carefully taken out of the shapes and were heated in a microwave oven for 1 minute at 1000 W, then for 2-3 minutes at 500 W, then for 1-2 minutes at 150 W for each shape. Heating was stopped when the inner part of the spinach shape was warm.

| | | Stability after | |
|---|---|---|---|
| | | heating | Water release |
| | | (% volume retained, | from spinach |
| No. | Thickening agent | observed visually) | shape |
| 1 | no | 10% | 10 |
| 2 | Potato starch 2% | 20% | 0 |
| 3 | Potato starch 4% | 75% | 0 |
| 4 | Potato starch 6% | 75% | 0 |
| 5 | Alginate 1% + CaCl2 | 70% | 20 |
| | (20 mm) | | |
| 6 | HydroxyPropylMethyl | 10% | 10 |
| | Cellulose/Methyl | | |
| | cellulose (K4M) 1% | | |
| 7 | Sugar beet pectin | 100% | 0 |
| | 2% + soybean | | |
| | peroxidase/H₂O₂ | | |

Pictures of spinach samples before and after heating:

It can be seen that the spinach with potato starch looses its shape in height; alginate looses its water while heating and partly its shape and HPMC/MC looses all shape while cross-linked pectin stabilized the shape completely and retained all water within its shape.

1. Frozen or chilled vegetable object capable of retaining its shape upon heating to room temperature and comprising a covalently cross-linked ferulyolated compound.

2. Vegetable object according to claim 1, wherein the ferulyolated compound is a pectin.

3. Vegetable object according to claim 1, capable of retaining its shape upon heating to 50° C., 75° C. or even 95° C.

4. Vegetable object according to claim 1, characterised in that a ferulyolated compound is at least partly oxidized after formation of the object.

5. Vegetable object according to claim 1, wherein the vegetable is spinach.

6. Process for the preparation of a frozen vegetable object according to claim 1, comprising the step of selecting vegetables, adding a ferulyolated compound and forming a cross-linked network.

7. Process according to claim 6, wherein the oxidation is carried out by an enzyme or enzymatic system.

8. Process according to claim 7, wherein the oxidation is carried out by an enzyme or enzymatic system which is present in situ.

9. Process according to claim 6, wherein the oxidation is carried out by a chemical oxidation system
